(19) United States
(12) Patent Application Publication
(10) Pub. No.: US 2010/0162863 A1
(43) Pub. Date: Jul. 1, 2010

(54) Method and apparatus for cutting fabric according to a pattern

(76) Inventor: Anthony W. Johnson, Lorton, VA (US)

Correspondence Address: MEREK, BLACKMON & VOORHEES, LLC, 673 S. WASHINGTON ST, ALEXANDRIA, VA, 22314, US

(21) Appl. No.: 12/659,260

(22) Filed: Mar. 2, 2010

Related U.S. Application Data
(63) Continuation-in-part of application No. 11/498,762, filed on Aug. 4, 2006, now abandoned.

(51) Int. Cl. B26D 7/06; B26D 5/42; B26D 7/02

(52) U.S. Cl. 83/23; 83/29; 83/375; 83/452

(57) ABSTRACT

Magnets secure a pattern and a fabric on a magnetically-attractive substrate including a top layer of a resilient material that is well-suited to receive a sharp edge to produce a clean cut in the fabric being cut. A kit according to the present invention includes a plurality of magnets, preferably of various sizes and shapes, and at least one magnetically-attractive substrate. The kit can have a plurality of substrates, fasteners for holding the substrates together, a cutting tool and packaging. At least one of the magnets includes a magnetic portion having a bottom surface and a nonmagnetic portion extending laterally from the magnetic portion.

### CROSS-REFERENCE TO RELATED APPLICATIONS

This application is a continuation-in-part of prior application Ser. No. 11/498,762, filed Aug. 4, 2006, which is hereby incorporated herein by reference in its entirety.

### BACKGROUND OF THE INVENTION

The present invention relates to cutting fabric in connection with a pattern, especially to cutting pieces of fabric, from fine silk to strong upholstery fabric, to be sewn or otherwise joined to form a garment. It especially relates to domestic sewing and sewing as a part of a small business.

A conventional way of cutting pieces of fabric to be sewn together to form a garment comprises spreading the fabric out flat, pinning light tissue or thin paper sewing patterns to the fabric, and cutting the fabric around the edges of the patterns. Typically, patterns comprise a plurality of pieces called “pattern pieces”. In this application, “pattern” is used to refer both to a pattern piece and to a plurality of related pattern pieces. Sometimes, disassembled articles of clothing or upholstery are used as pattern pieces. Pinning the thin paper patterns to the fabric is time-consuming. In addition, pinning some fabrics can be difficult. For greater speed, it is also known to use weights rather than pins to hold the patterns in place on the fabric. A drawback of the use of weights is that weights heavy enough to be effective are so large that they interfere with cutting the fabric at corners and narrow portions of the patterns. In addition, distortion and tearing of the patterns has been an issue when pins or weights are used to control clothing patterns.

The force of magnetic attraction on conventional magnets has the drawback of distorting the sewing patterns and the fabric to be cut, causing puckering in the patterns and fabric, especially if the fabric is thick. This situation is made worse by the need for stronger magnets as the thickness of the fabric increases. The closer a magnet is to the edge of a pattern and, thus, the closer a magnet is to the portion of the fabric to be cut, the greater the distortion caused by the magnet in the edge of the pattern and in the portion of the fabric to be cut. This limits the accuracy and precision with which the fabric can be cut. Furthermore, although relative movement between the pattern and the fabric during cutting is reduced in accordance with the proximity of the magnet to the edge of the pattern, the closer a conventional magnet is to the edge of a pattern, the greater is additional distortion in the pattern and material caused by lateral magnetic attraction imposed on the magnet by a steel cutting edge of a cutting tool that passes close by the magnet while making a cut.

### SUMMARY OF THE INVENTION

By the present invention, magnets of various sizes, shapes and strengths are used instead of pins or weights to secure a pattern relative to a material, such as a fabric, so that the fabric can be cut accurately and precisely in accordance with the pattern. For this purpose, a magnetically-attractive substrate, such as a plate of steel, is placed under the fabric. As a result, the pattern and the fabric are clamped between the magnets and the substrate, and the pattern and the fabric are prevented from moving relative to one another and relative to the substrate. By “magnetically-attractive” is meant a material that is able to attract a magnet or be attracted by a magnet. Preferably, the magnetically-attractive substrate includes a top layer of a resilient or other material that is well-suited to receive a sharp edge, such as that of a cutting wheel, to produce a clean cut in the fabric. It is preferred that the top layer is bonded or otherwise attached to a magnetically-attractive portion of the substrate. The magnetically-attractive area extends to the edge of the substrate around the entire perimeter of the substrate. Thus, the magnetically-attractive area extends throughout all of the substrate. In view of this, a plurality of the substrates can be positioned in abutment with one another along their edges, lengthwise or widthwise, to provide a larger cutting surface under all of which the magnetically-attractive area is present. Connectors can be used to secure the substrates to one another.

Each of a plurality of related pattern pieces must be lined up with the grain of the fabric being cut. All such pattern pieces can be lined up with the grain of the fabric being cut, if the cutting area is large enough. All fabrics, from the finest silk to the sturdiest upholstery material, are quickly, efficiently, and securely held in place by the magnets, under any type of pattern piece, until it is cut.

Also by the present invention, at least some magnets have a nonmagnetic portion or portions extending laterally from a magnetic portion, wherein the nonmagnetic portions are arranged to contact the pattern and the fabric. Such magnets hold the pattern and the fabric still without distorting them at the portion of the fabric to be cut, or with reduced distortion at the portion of the fabric to be cut, compared with conventional magnets, with which the magnetic portion is positioned at the portion of the fabric to be cut. The lateral extension of magnets having a nonmagnetic portion or portions extending laterally from a magnetic portion provides control of the pattern and the fabric at the edge of the pattern and the portion of the fabric to be cut, with no distortion or reduced distortion. Distortion can affect the accuracy of cutting. In addition, with magnets having a nonmagnetic portion or portions extending laterally from a magnetic portion, the magnetic portions are positioned sufficiently far from the edges of the pattern that there is no magnetic attraction between the magnet and a steel cutting edge of a cutting tool that passes close by the magnet while making a cut.

Magnets having an extending nonmagnetic portion are especially useful when disassembled articles of clothing or upholstery material are used as patterns. The extensions hold the curved edges of worn pattern pieces much better than do conventional magnets. In addition, nonmagnetic extensions can be placed right on pattern edges without disturbing a conventional razor-sharp steel cutting wheel. Placing conventional magnets, which are without any nonmagnetic extension, too close to a pattern edge causes the steel cutting wheel to be pulled towards the magnet, and the magnet to attach itself to the wheel, thereby disrupting the cutting process.

A kit according to the present invention includes a plurality of magnets, preferably of various sizes and shapes, and at least one magnetically-attractive substrate. The kit can have a plurality of magnetically-attractive substrates, a cutting tool and packaging.

The substrates, which are essentially self-healing craft mats backed with a magnetically attractive material, can be produced in an unlimited variety of sizes to accommodate doll clothing, quilting squares, and even large pieces for upholstery and window treatments. One particularly useful shape and size for the self-healing craft mats is a 2-foot by 3-foot rectangle. The substrates can be permanently set into the surface of a sewing table or craft table.

### BRIEF DESCRIPTION OF THE DRAWING

FIG. 1 is a schematic plan view of a material cutting apparatus according to the present invention in use in connection with patterns and a piece of material;

FIG. 2 is a partial end view of a material cutting apparatus according to the present invention, with cutting being done with a cutting wheel;

FIG. 3 is a schematic plan view of a material cutting kit according to the present invention, including a package;

FIG. 4 is a top plan view of a material cutting apparatus according to the present invention in use in connection with patterns and a piece of fabric;

FIG. 5 is an enlarged top plan view of a material cutting apparatus according to the present invention in use in connection with a pattern and a piece of fabric;

FIG. 6 is an enlarged perspective view, from the bottom, of a magnet according to the present invention; and

FIG. 7 is an enlarged perspective view, from the bottom, of another magnet according to the present invention.

### DETAILED DESCRIPTION OF THE PREFERRED EMBODIMENTS

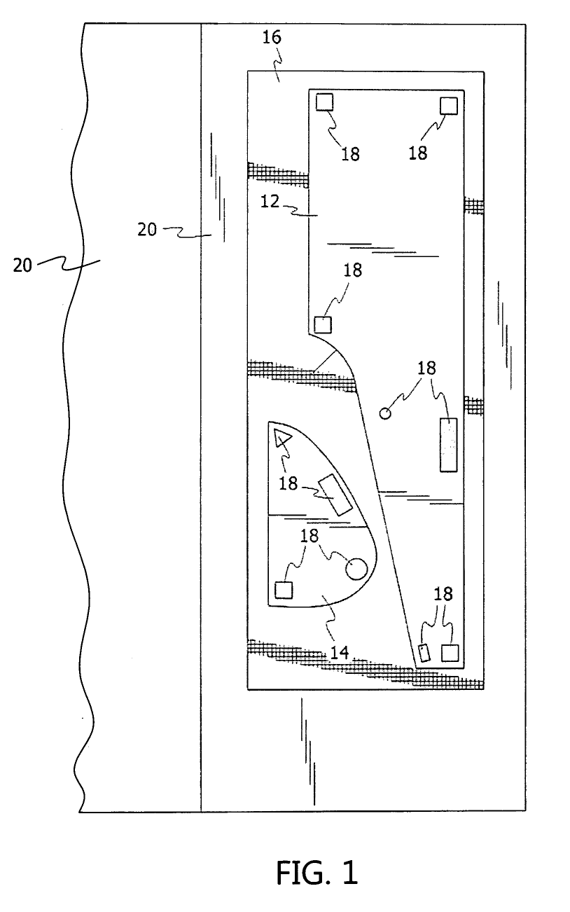

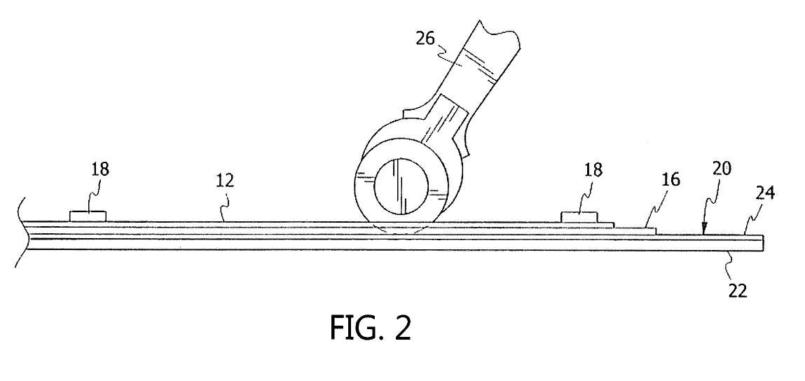

As can be seen from FIGS. 1 and 2, a material cutting apparatus according to the present invention is shown in use with pattern pieces, or patterns, 12 and 14 and a piece of fabric 16. In one aspect of the present invention, the material cutting apparatus includes magnets 18, which are used instead of pins or weights to secure the patterns 12 and 14 relative to the fabric 16, so that it can be cut accurately and precisely in accordance with the patterns. For this purpose, the material cutting apparatus also includes a magnetically-attractive substrate 20, comprising a magnetically-attractive material 22, for example, a plate of steel, that is placed under the fabric 16. As a result, the patterns 12 and 14 and the fabric 16 are clamped between the magnets 18 and the substrate 20, and the patterns and the fabric are prevented from moving relative to one another and relative to the substrate. As can be appreciated from FIG. 1, the patterns 12 and 14, and other patterns, if needed for a garment or other product, are arranged on the fabric 16 in a way that minimizes waste of fabric.

Preferably, the magnetically-attractive substrate 20 also comprises a top layer 24 of a resilient or other material that is well-suited to produce a clean cut in the fabric, when a sharp edge, such as that of a conventional razor-sharp cutting wheel 26, is applied. A material that is particularly well-suited as the top layer 24 is the material of a conventional self-healing craft mat. Self-healing craft mats are made to be used in combination with razor-sharp cutting wheels to cut fabric. Razor-sharp cutting wheels become dull almost immediately when used to cut on other surfaces. Most cutting tools other than razor-sharp cutting wheels and scissors (for domestic use) do not work well on fabric.

It is preferred that the top layer 24 be bonded or otherwise attached to the magnetically-attractive material 22 of the substrate 20. As can be appreciated from FIG. 2, the magnetically-attractive area 22 extends throughout the substrate 20 to the edge of the substrate. This is true around the entire perimeter of the substrate 20. Such a substrate 20 is another aspect of the apparatus according to the present invention.

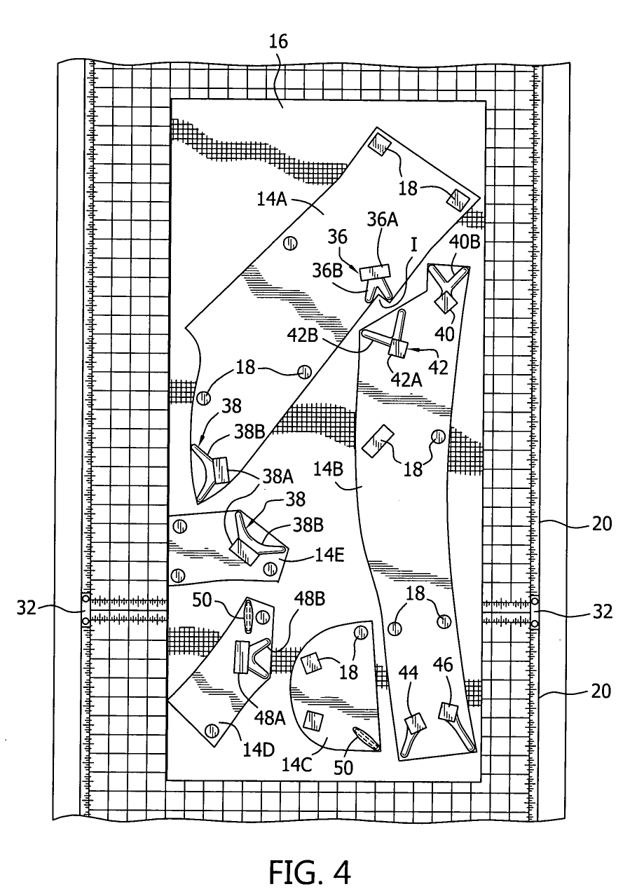

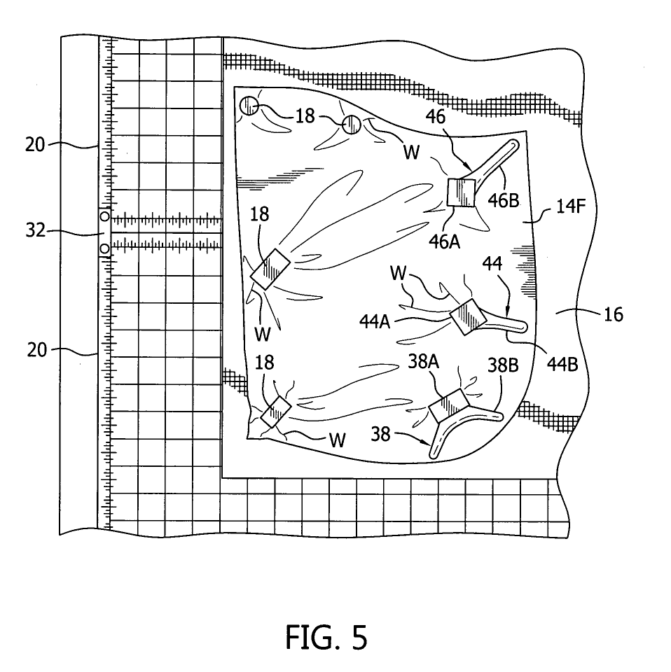

The present invention will be described further with reference to the pattern 12, it being understood that the description also applies to the pattern 14 of FIG. 2, the patterns 14A-14E of FIG. 4, the pattern 14F of FIG. 5, and to other patterns that are not illustrated. The magnetically-attractive material 22 defines a magnetically-attractive area that is at least as large as the area of the pattern 12 with which the substrate is being used. The magnets 18 are adapted to hold the fabric 16 to be cut and the pattern 12 to the magnetically-attractive area by magnetic attraction. In this regard, it is important that each magnet 18 be strong enough to hold the pattern 12 and the fabric 16 firmly. Like the magnetically-attractive material 22, the top layer 24 has an area at least as large as the area of the pattern 12.

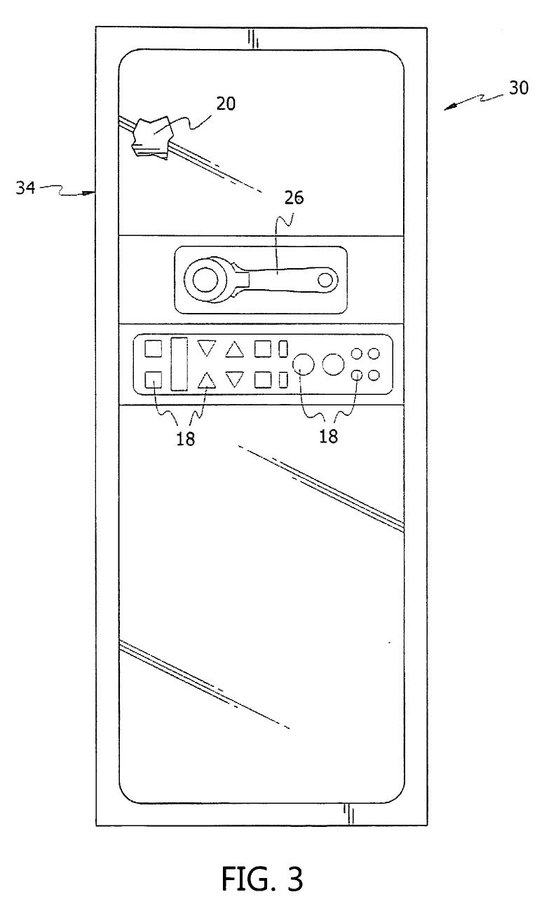

As can be appreciated from FIG. 3, a kit 30 according to the present invention includes a plurality of magnets 18, preferably of various sizes and shapes, and at least one magnetically-attractive substrate 20. Some magnets 18 can be relatively long and thin, for example, about ½ inch wide and 1 inch or more long, to fit into long, narrow pattern shapes. Other magnets can be triangular, having, for example, the shape of an equilateral triangle, to fit into pattern shapes having relatively sharp angles. Other magnets can be square, and still others can be circular. It is preferred that the kit 30 have at least twenty magnets 18.

The kit 30 can have a plurality of the substrates 20, or substrate sections, that can be used individually or secured together in abutment with one another along their edges, lengthwise or widthwise, to form a single substrate of larger area, under all of which the magnetically-attractive area is present, and thereby provide a larger cutting surface. For such securing, the kit 30 can include clips or other conventional fasteners 32 (FIGS. 4 and 5) that fit over the edges of the substrates 20 being joined. Where the kit 30 has a plurality of substrates 20, all of the substrates can have the same shape and size, for example, a rectangular shape of about 2 feet by 3 feet, or the substrates can have differing sizes and/or shapes. The kit 30 can also include a cutting tool 26, such as a conventional razor-sharp cutting wheel, that is adapted to cut fabric by pressing the fabric against the substrate.

Packaging 34 can hold together all of the parts of the kit 30 for sale and storage. In the illustrated packaging 34, a plurality of the magnetically-attractive substrates 20 can be held one in front of the other such that only the front substrate is visible, especially where all of the substrates 20 are of the same size and shape.

Also by the present invention, as can be seen from FIGS. 4-7, the kit 30 can include one or more magnets 36-54 each having a nonmagnetic portion or portions extending laterally from a magnetic portion, wherein the nonmagnetic portion, as well as the magnetic portion, is arranged to contact the pattern and the fabric. Typically, the magnetic portion of each such magnet is a conventional magnet. The nonmagnetic portion can be made of a plastic.

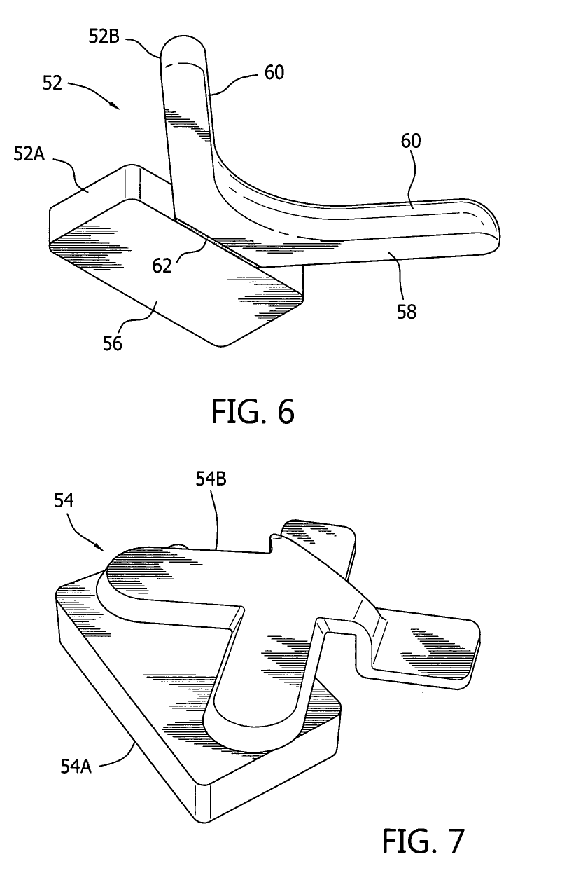

As can be seen from FIG. 6, the magnetic portion 52A of, for example, the magnet 52 has a bottom surface 56, and the nonmagnetic portion 52B extends laterally from the magnetic portion. The nonmagnetic portion 52B has a bottom surface 58 that is coplanar with the bottom surface 56 of the magnetic portion 52A. The nonmagnetic portion 52B has an end that is distal to the magnetic portion 52A, and the bottom surface 58 of the nonmagnetic portion 52B, all the way from the magnetic portion 52A to the end distal to the magnetic portion, is coplanar with the bottom surface 56 of the magnetic portion 52A. As a result, when the magnet 52 is placed on a pattern, the bottom surface of the magnet is in continuous contact with the pattern throughout the entire bottom surface of the magnet. The nonmagnetic portion 52B extends laterally from about 1 inch to about 2 inches from the magnetic portion 52A, thereby defining a lateral extension 60. The ratio of the length to the width of the lateral extension 60 is preferably in the range of from about 2 to 1 to about 4 to 1.

In the magnets 36-42 and 50-54, the magnetic portion defines two lateral extensions defining an angle with one another. Typically, the nonmagnetic portion extends laterally from about 1 inch to about 2 inches from the magnetic portion, and the ratio of the length to the width of each lateral extension is from about 2 to 1 to about 4 to 1. In the magnets 40, 42, 48, 52 and 54, the lateral extensions define approximately a right angle with one another. In the magnet 36, the lateral extensions define an acute angle with one another; and in the magnets 38, the lateral extensions define an obtuse angle with one another. In the magnets 50, the lateral extensions extend from opposite ends of the magnetic portion (indicated by broken lines in FIG. 4) and are colinear with one another. In the magnets 40, 42, 44 and 46, the magnetic portion, for example, a square or other rectangle, defines a corner, and the nonmagnetic portion extends laterally from the corner in the direction in which the corner points.

As can be appreciated from FIG. 5, placing conventional magnets 18 too close to a pattern edge causes the pattern and the fabric, especially thick fabrics, to pucker at the edge, thereby producing wrinkles W at the edge that reduce the precision of the cut to be made in the fabric. As can be appreciated also from FIG. 5, placing magnets having a magnetic portion and a nonmagnetic portion, such as magnets 38, 44 and 46, with the nonmagnetic portions close to a pattern edge and the magnetic portions spaced from the pattern edge, avoids causing the pattern and the fabric to pucker at the edge, thereby avoiding wrinkles at the edge and improving the precision of the cut to be made in the fabric.

The present invention also relates to a method for cutting material, especially fabric, in connection with a pattern, as can be appreciated from FIGS. 1-5. In accordance with the method, which, for convenience, is described in connection with the apparatus disclosed herein, fabric 16 to be cut is put on, and spread out on, a substrate 20 having a magnetically-attractive area. The magnetically-attractive area is defined by a magnetically-attractive material 22, that is at least as large as the area of a pattern 12. The pattern 12, which can be a conventional sewing pattern made of thin paper, is spread out on the fabric 16 such that the magnetically-attractive area underlies the entire pattern, with the fabric to be cut interposed between the pattern and the magnetically-attractive area. When the fabric 16 and the pattern 12 are spread out and are smooth, magnets 18 are positioned on the pattern 12 to restrain movement of the pattern and the fabric relative to one another and relative to the substrate 20.

The magnets 18 are positioned entirely within the area of the pattern, near the edges of the pattern, especially in corners, and in spaced relationship with one another. The magnets 18 are typically positioned such that the edge of each magnet that is the closest to the edge of the pattern 12 is about ¼ inch to 1 inch from the edge of the pattern. Then, the fabric 16 is cut by pressing a cutting edge, such as that of a razor-sharp cutting wheel 26, into the fabric and moving the cutting wheel along the outline provided by the pattern 12, while the fabric is supported by the substrate 20. The substrate 20 can have a second material 24 adapted to receive a cutting edge in a manner that results in an even cut in the fabric to be cut, in which case the pattern 12 is preferably placed entirely on the second material.

A plurality of substrates often are used together. As can be seen from FIGS. 1, 4 and 5, when a plurality of the substrates 20 are used together, the substrates are placed in contact with one another and preferably secured together with fasteners 32, or the like. Fabric 16 is put onto the resilient material 24 of at least one of the substrates 20. A pattern, for example, the pattern 12 or 14 of FIG. 1, or any one of, or all of, the patterns 14A-14F of FIG. 4, is placed onto the fabric 16 such that the magnetically-attractive area of the substrate or substrates 20 on which the fabric is put underlies the entire pattern, with the fabric interposed between the pattern and the area of the resilient material of the substrate(s) on which the fabric is put. The substrate or substrates 20 on which the fabric 16 is put has a magnetically-attractive area that is at least as large as the area of the pattern and a resilient material area that is at least as large as the area of the pattern.

A plurality of magnets, for example, a plurality of magnets selected from the types of magnets 18 and 36-54, is positioned on the pattern to restrain movement of the pattern and the fabric 16 relative to one another and relative to the at least one substrate, and the fabric is cut using the pattern as a guide. Preferably, the cutting is done by pressing a cutting edge, such as the cutting edge of a conventional razor-sharp cutting wheel 26 into the fabric while the fabric is supported by the at least one substrate.

In the cutting method according to the present invention, one or more of the magnets, for example, magnets of the types of magnets 36-54, each having a magnetic portion 36A-54A and a nonmagnetic portion 36B-54B, can be used. When a magnet having a magnetic portion and a nonmagnetic portion is used, the nonmagnetic portion is positioned adjacent to a cut to be made in the fabric, and the magnetic portion is positioned farther from the cut to be made than the nonmagnetic portion is positioned. For example, for the magnet 46 as seen in FIG. 5, the nonmagnetic portion 46B is positioned adjacent to a cut to be made in the fabric 16, around the perimeter of the pattern 14F, and the magnetic portion 46A is positioned farther from the cut to be made than the nonmagnetic portion is positioned. The magnetic portion 46A is spaced sufficiently from the cut to be made to avoid magnetic attraction between the magnet 46 and a magnetically-attractive cutting tool, such as a conventional razor-sharp cutting wheel 26. The bottom surface of the magnetic portion 46A and the bottom surface of the nonmagnetic portion 46B are placed in contact with the pattern 14F. The magnetic portion 46A is positioned at least ½ inch from the cut to be made, preferably from about 1 inch to about 3 inches from the cut to be made.

The description above of the use of the magnet 46 also applies to each of the magnets 36-44 and 48-54. For each of the magnets of the types of magnets 36-54, the magnetic portion 36A-54A and the nonmagnetic portion 36B-54B are secured to one another. For this purpose, an adhesive or fasteners or other securing arragement can be used. In FIG. 6 an adhesive 62 is shown securing together the magnetic portion 52A and the nonmagnetic portion 52B of the magnet 52.

When a magnet having a nonmagnetic portion defining two lateral extensions is used, both lateral extensions can be positioned adjacent to a cut to be made in the fabric. For example, both lateral extensions 60 of the nonmagnetic portion 52B of the magnet 52 can be positioned adjacent to a cut to be made in the fabric. Furthermore, as can be appreciated from FIG. 4, in the case of a recess or indentation in the edge of a pattern, such as the indentation I in the edge of the pattern 14A, a magnet having a nonmagnetic portion defining two lateral extensions at a suitable angle to one another, such as the magnet 36, can be selected and positioned such that one magnet is able to hold the pattern 14A and the fabric 16 in place on both sides of the recess or indentation.

As can be seen from FIG. 7, in the magnet 54, the nonmagnetic portion 54B defines a cross of which two arms are secured to the top of the magnetic portion 54A. A central portion of the cross has a step down to end portions of the other two arms extending laterally from a side of the magnetic portion 54A. A bottom surface of each of the stepped-down end portions is coplanar with the bottom surface of the magnetic portion 54A.

The following are examples of cutting fabric in accordance with the present invention.

### EXAMPLE 1

A pattern to make a woman's jacket calls for two and a half yards of 56″ wide fabric.
Three rectangular cutting mats according to the present invention, each two feet wide and three feet long, are placed together widthwise on a 72″ cutting table. The fabric is folded in half lengthwise and placed evenly across the three mats. The pattern pieces are cut out of a pattern sheet. Using the layout provided by pattern, as many of the pattern pieces that will fit are placed on the fabric. Domestic pattern kits provide illustrations on laying out pattern pieces. As the pattern pieces are laid out, magnets are placed on the pattern pieces, which are on the fabric, to secure the pattern pieces and the fabric. Fabric pieces are cut out of fabric using a cutting wheel. The pieces of cut fabric are marked, and the magnets adjusted, if necessary. The fabric is adjusted across the mats so that more of the pattern pieces can be accommodated, and the steps described above are followed for the more pattern pieces.

### EXAMPLE 2

For larger projects, such as window treatments or upholstery:
Six rectangular cutting mats according to the present invention, each two feet wide and three feet long, are placed together widthwise and lengthwise on the floor or a large cutting area. The fabric out is laid out evenly across the mats. Magnets are placed as appropriate on patterns or old upholstery material. Fabric pieces are cut out of the fabric using a cutting wheel. The pieces of cut fabric are marked, and the magnets adjusted, if necessary. The fabric is adjusted across the mats so that more of the pattern pieces can be accommodated, and the steps described above are followed for the additional pattern pieces.

It will be apparent to those skilled in the art and it is contemplated that variations and/or changes in the embodiments illustrated and described herein may be made without departure from the present invention. Accordingly, it is intended that the foregoing description is illustrative only, not limiting, and that the true spirit and scope of the present invention will be determined by the appended claims.

1. A kit for use in the cutting of fabric in connection with a pattern comprising:
a plurality of substrates securable together to form a larger substrate having a larger area than the area of just one of the substrates, wherein each substrate has a first material having a magnetically-attractive area extending throughout the substrate to the edge of the substrate, each substrate also having a second material secured to the first material; and
magnets adapted to hold to the magnetically-attractive area, by magnetic attraction, the pattern and the fabric, wherein the second material is a resilient material that is adapted to produce an even cut in the fabric, when a sharp edge is applied to the fabric to cut the fabric.

2. The kit according to claim 1, wherein the magnetically-attractive area comprises a plate made of a magnetically-attractive material.

3. The kit according to claim 1, wherein at least one of the magnets comprises a magnetic portion having a bottom surface and a nonmagnetic portion extending laterally from the magnetic portion, the nonmagnetic portion having a bottom surface coplanar with the bottom surface of the magnetic portion.

4. The kit according to claim 3, wherein the nonmagnetic portion has an end distal to the magnetic portion, and the bottom surface of the nonmagnetic portion, from the magnetic portion to the end distal to the magnetic portion, is coplanar with the bottom surface of the magnetic portion.

5. The kit according to claim 3, wherein the nonmagnetic portion extends laterally from about 1 inch to about 2 inches from the magnetic portion.

6. The kit according to claim 3, wherein the nonmagnetic portion extending laterally from the magnetic portion defines a lateral extension having a length and a width, and the ratio of the length to the width is from about 2 to 1 to about 4 to 1.

7. The kit according to claim 3, wherein the magnetic portion defines a corner and the nonmagnetic portion extends laterally from the corner.

8. The kit according to claim 3, wherein the nonmagnetic portion extending laterally from the magnetic portion defines two lateral extensions defining an angle with one another.

9. The kit according to claim 8, wherein each lateral extension has a length and a width, and the ratio of the length to the width is from about 2 to 1 to about 4 to 1.

10. The kit according to claim 8, wherein the lateral extensions define approximately a right angle with one another.

11. The kit according to claim 8, wherein the lateral extensions defining an acute angle with one another.

12. The kit according to claim 8, wherein the lateral extensions defining an obtuse angle with one another.

13. The kit according to claim 1, wherein the resilient material is the material of a conventional self-healing craft mat.

14. The kit according to claim 1, further comprising a cutting instrument adapted to cut fabric by pressing the fabric against a substrate.

15. In combination, for use in connection with cutting fabric:
a pattern having an area;
at least one substrate having a first material having a magnetically-attractive area at least as large as the area of the pattern and extending throughout the substrate to the edge of the substrate, the at least one substrate also having a second material secured to the first material; and
a plurality of magnets that are movable relative to the pattern, the magnets holding the pattern to the magnetically-attractive area by magnetic attraction, and adapted to hold fabric to the magnetically-attractive area by magnetic attraction, wherein the second material of the substrate is a resilient material that is adapted to produce an even cut in the fabric, when a sharp edge is applied.

16. The combination according to claim 15, wherein the magnetically-attractive area comprises a plate made of a magnetically-attractive material, said plate having an area at least as large as the area of the pattern.

17. The combination according to claim 16, wherein the second material has an area at least as large as the area of the pattern.

18. The combination according to claim 17, wherein the second material is the resilient material of a conventional self-healing craft mat.

19. The combination according to claim 15, wherein the at least one substrate comprises a plurality of substrates securable together to form a larger substrate having a larger area than the area of just one of the substrates.

20. A method for use in connection with cutting fabric in connection with a pattern having an area comprising:
placing in contact with one another a plurality of substrates each having a magnetically-attractive material extending throughout the substrate to the edge of the substrate and a resilient material extending throughout the substrate and secured to the magnetically-attractive material;
putting fabric on the resilient material of at least one of the substrates, wherein the at least one substrate on which the fabric is put has a magnetically-attractive area that is at least as large as the area of the pattern and an area of the resilient material that is at least as large as the area of the pattern;
placing the pattern on the fabric such that the magnetically-attractive area of the at least one substrate on which the fabric is put underlies the entire pattern, with the fabric interposed between the pattern and the area of the resilient material of the at least one substrate on which the fabric is put;
positioning magnets on the pattern to restrain movement of the pattern and the fabric relative to one another and relative to the at least one substrate; and
cutting the fabric in accordance with the pattern.

21. The method according to claim 20, wherein the act of cutting comprises pressing a cutting edge into the fabric while the fabric is supported by the at least one substrate.

22. The method according to claim 20, wherein at least one of the magnets has a bottom surface and a nonmagnetic portion extending laterally from the magnetic portion, the nonmagnetic portion having a bottom surface coplanar with the bottom surface of the magnetic portion, and wherein the act of positioning comprises positioning the nonmagnetic portion of the at least one of the magnets adjacent to a cut to be made in the fabric and positioning the magnetic portion of the at least one of the magnets farther from the cut to be made than the nonmagnetic portion is positioned, the magnetic portion being spaced sufficiently from the cut to be made to avoid magnetic attraction between the at least one of the magnets and a magnetically-attractive cutting tool.

23. The method according to claim 22, wherein the act of positioning comprises positioning the magnetic portion at least ½ inch from the cut to be made.

24. The method according to claim 22, wherein the act of positioning comprises positioning the magnetic portion from about 1 inch to about 3 inches from the cut to be made.

25. The method according to claim 20, wherein the act of positioning comprises positioning the magnets in spaced relationship with one another.

26. The method according to claim 22, wherein the act of positioning comprises positioning the bottom surface of the magnetic portion in contact with the pattern.

27. The method according to claim 22, wherein the act of positioning comprises positioning the magnet entirely within the area of the pattern.

28. The method according to claim 22, wherein the nonmagnetic portion defines two lateral extensions extending laterally from the magnetic portion and defining an angle with one another, and the act of positioning comprises positioning both lateral extensions adjacent to a cut to be made in the fabric.

29. The method according to claim 20, wherein the resilient material is the material of a conventional self-healing craft mat.
